(19) United States
(12) Patent Application Publication
(10) Pub. No.: US 2023/0383907 A1
(43) Pub. Date: Nov. 30, 2023

(54) LONG HEAT PATH SUPPORT STRUCTURE

(71) Applicant: BENNAMANN SERVICES LTD, Newquay, Cornwall (GB)

(72) Inventors: Christopher Mark MANN, St. Mawgan, Cornwall (GB); Tom Richard TAYLOR, Wadebridge, Cornwall (GB); Luke James MANN, Truro, Cornwall (GB); Thomas William BRADSHAW, Oxfordshire (GB)

(73) Assignee: BENNAMANN SERVICES LTD, Newquay, Cornwall (GB)

(21) Appl. No.: 18/021,762

(22) PCT Filed: Aug. 16, 2021
(86) PCT No.: PCT/IB2021/057535

§ 371 Date: Feb. 16, 2023

Related U.S. Application Data
(60) Provisional application No. 63/066,544, filed on Aug. 17, 2020.

(51) Int. Cl. F17C 3/08; F17C 5/04

(52) U.S. Cl. CPC F17C 3/085; F17C 5/04; F17C 2201/0119; F17C 2201/032; F17C 2203/014; F17C 2203/032; F17C 2203/0325; F17C 2203/0333; F17C 2203/0391; F17C 2203/0629; F17C 2203/0643; F17C 2203/0646; F17C 2221/033; F17C 2223/0161; F17C 2227/0383; F17C 2260/033; F17C 2265/066; F17C 2270/0168; F17C 2270/0509

(57) ABSTRACT

Storage systems and methods of manufacturing and using the same. A storage tank is provided with an inner vessel, an outer vessel, and a support system between the vessels. The support system may comprise a repeating pattern of openings that effectively lengthens the heat path between the inner and outer vessels.

### CROSS REFERENCE TO RELATED APPLICATIONS

The present application claims priority to U.S. Provisional Application No. 63/066,544 filed on Aug. 17, 2020, the disclosure of which is incorporated here in its entirety by reference.

### FIELD OF THE DISCLOSURE

Disclosed are embodiments relating generally to cryogenic storage containers, including for the storage of gaseous or liquid methane.

### BACKGROUND

The cryogenic nature liquid methane storage and its delivery as a fuel to engines and other power generation systems can present several technical challenges as compared to conventional, non-cryogenic liquid fuels such as diesel, gasoline, and butane.

For example, in terms of storage, to minimize the loss of methane gas through venting, a storage tank 100 illustrated in FIG. 1 may be provided. Often, such a tank is able to extend the period over which the methane can remain liquid by storing it in a high pressure vacuum insulated vessel, and can include an outer vacuum jacket 102, an inner vessel 104, super insulation 106, and an evacuation port 108. Other materials may be cryogenically stored in similar arrangements.

The typical tank pressure and hold times for liquid methane stored in a tank as illustrated in FIG. 1 are provided in FIG. 2A. In this example, the pressure and hold-times are provided in accordance with the saturation-vapor curve illustrated in FIG. 2B (table data obtained from CRC Handbook of Chemistry and Physics 44th ed.). This curve shows a relationship between equilibrium pressure and temperature for liquid methane, where the curve is based on:

$${log}_{10} {P}_{mmHg} = 6.61184 - \frac{389.93}{266.0 + {T}_{° C .}}$$

Above a critical point of −82.6C, methane requires impracticable pressures to keep it as a liquid.

The outer section 102 can be built to withstand vacuum on the inside, and with the inner vessel suspended inside the vacuum containing the liquid. The vacuum and/or insulation limits the heat load on the inner tank by reducing the heat gained through conduction. However, when an inner vessel 104 is mounted within an outer vessel 102, the mounting structure may create a heat path between the inner and outer vessels. Thus, heat can be introduced to the inner vessel housing the cryogenic material via these heat paths, which can lead to reduced hold-times.

Accordingly, there remains a need for improved support structures.

### SUMMARY

According to embodiments, a mounting arrangement for the internal vessel of a cryogenic storage apparatus is provided, which can provide a low cost alternative to conventional support structures. In certain aspects, a device is provided that supports the internal vessel of the cryogenic storage apparatus and that also minimizes the heat load on the inner vessel. The apparatus may be, for example, a Dewar.

According to embodiments, a storage system (e.g., a tank) is provided, which comprises: an outer vessel; an inner vessel arranged within the outer vessel; and a support structure connecting the inner vessel to the outer vessel, wherein the support structure has at least one surface with a plurality of openings arranged in a repeating pattern. This arrangement can extend the effective heat path length between the outer and inner vessels.

According to embodiments, a method of manufacturing a support structure is provided. The method comprises the steps of: obtaining a metal sheet (e.g., a rectangular sheet of stainless steel or aluminum); forming a repeated pattern of openings (e.g., rows of offset cut-outs) in the metal sheet; and connecting first and second ends of the metal sheet (e.g., wrapping the metal sheet) to form a support collar. In certain aspects, forming the repeated pattern of openings comprises cutting a plurality of slits in the metal sheet, for instance, using one or more of a water jet and a blade.

According to embodiments, a method of manufacturing a storage tank is provided, which comprises the steps of: attaching a support structure to an inner vessel; and attaching the support structure to an outer vessel, such that the inner vessel is suspended within the outer vessel by the support structure, wherein the support structure comprises at least one surface with a plurality of openings arranged in a repeating pattern. In some embodiments, attaching the support structure to the inner and outer vessels comprises attaching a first collar (or other support element) at a first distal end of the vessels along a longitudinal direction and attaching a second collar (or other support element) at a second distal end of the vessels along a longitudinal direction. While a collar is used as an example, other support elements, such as plates or rods, may be used in some embodiments.

According to embodiments, the storage tanks and support systems disclosed herein can be implemented on a vehicle, for instance as part of a fuel delivery system. In some embodiments, the storage tanks and/or support systems may be used as a pressurized source fuel tank (low or high pressure) within the delivery system, or in connection with a gas buffer of the system. In certain aspects, such tanks may be non-cylindrical, for example, shaped or sized to fit the particular vehicle.

According to embodiments, a support structure is provided. In certain aspects, the support a plurality of openings arranged in a repeating pattern, for instance, to extend the heat path across the structure. The structure may be, for instance, a collar, one or more plates, or one or more rods.

### BRIEF DESCRIPTION OF THE DRAWINGS

The accompanying drawings, which are incorporated herein and form part of the specification, illustrate various embodiments.

FIG. 1. illustrates a storage tank.

FIGS. 2A and 2B illustrate pressure information for storage.

FIGS. 3A and 3B illustrate storage tanks according to some embodiments.

FIGS. 4A-4F illustrate a support system according to some embodiments.

FIGS. 5A-5C illustrate a storage tank according to some embodiments.

FIGS. 6A and 6B illustrate a storage tank according to some embodiments.

FIG. 7 illustrates a storage tank according to some embodiments.

FIG. 8 illustrates a storage tank according to some embodiments.

FIG. 9 illustrates a process according to some embodiments.

FIG. 10 illustrates a process according to some embodiments.

FIG. 11 illustrates a process according to some embodiments.

FIGS. 12A-12C illustrate a storage tank and support structures according to some embodiments.

FIG. 13. illustrates a system for the storage and delivery of fuel according to some embodiments.

FIG. 14 illustrates a storage vessel according to some embodiments.

FIGS. 15A-15D illustrate a storage vessel according to some embodiments.

FIGS. 16A and 16B illustrate a storage vessel according to some embodiments.

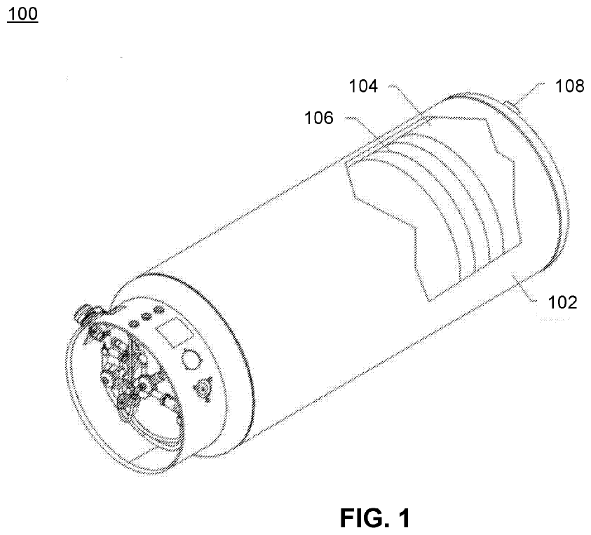

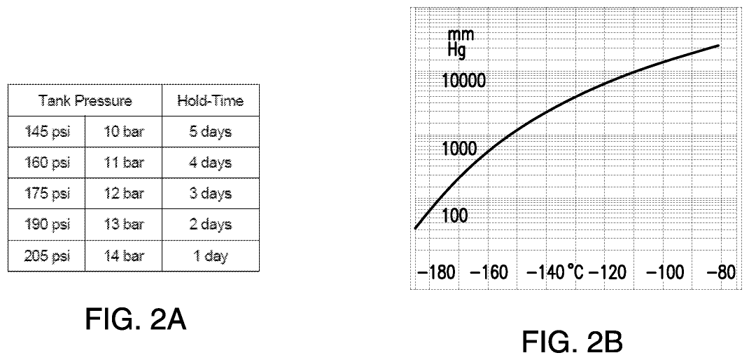

Together with the description, the drawings further serve to explain the principles of the disclosure and to enable a person skilled in the pertinent art to make and use the embodiments disclosed herein. In the drawings, like reference numbers indicate identical or similar functionality.

### DETAILED DESCRIPTION

When storing a cryogenic liquid or gas, the heat load on a cryogenic storage Dewar should be minimized to increase the hold time before the pressure in the vessel reaches levels that require venting. In the context of minimizing the release of a gas with a high global warming potential (e.g., methane), such venting can be highly undesirable. According to embodiments, the heat path between an inner storage vessel and warmer components (e.g., the outer vessel or environment) is effectively minimized, thereby improving hold times and limiting the need to vent gas.

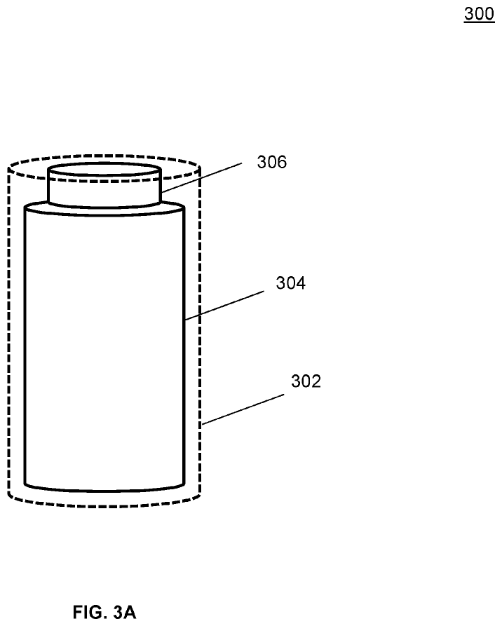

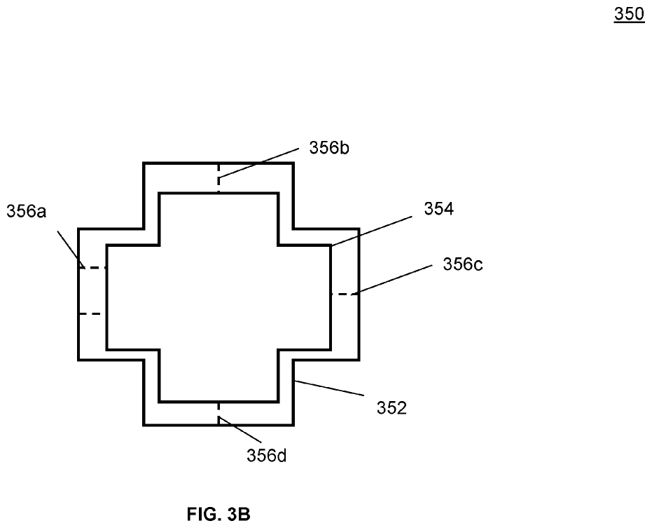

Referring now to FIG. 3A, a storage system 300 is provided. Storage system 300 may be, for instance, a tank for storing cryogenic liquids or gasses, such as methane, liquid nitrogen, liquid oxygen, or hydrogen. Other materials may be stored according to embodiments. In this example, an inner vessel 304 is suspended within an outer vessel 302 using a support structure 306, such as a collar or one or more plates. According to embodiments, the support structure has a plurality of openings arranged in a repeating pattern. This could be, for instance, a series of staggered cut-out portions that effectively increase the length of the heat path between the inner and outer vessels. In some embodiments, the space between the inner and outer vessels 304, 302 is vacuum. As an alternative, or in addition to vacuum, one or more intermediate layers can be used (not shown). Such intermediate layers could include, for example, a radiation shield, insulating film (e.g., a multilayer film), Aerogel, and/or PU foam (or similar). These layers can help reduce the effects of thermal radiation. In certain aspects, a radiation shield and/or multi-layer insulation may reduce the heat load from radiation. In certain aspects, Aerogel and PU foam may reduce the heat load from conduction (e.g., where hard vacuum is not present). The use of PU foam can, in some instances, provide mechanical support.

While the tank and vessels of FIG. 3A are illustrated with cylindrical shapes, embodiments may also use non-cylindrical tanks/vessels (e.g., rectangular, rounded rectangular, or irregular shapes). In certain aspects, the improved heat transport properties of disclosed embodiments enable the use of low pressure, non-cylindrical tanks with long hold times. For instance, a tank may be irregularly shaped to fit within a vehicle, with one or more support structures according to embodiments used at various locations to constrain the movement of the inner vessel within the outer vessel. While the support structure 306 is illustrated as narrower in diameter than the inner vessel 304, in some embodiments, the support structure 306 may be equally as wide, or wider than, the inner vessel 304.

An example of an irregular tank is provided in FIG. 3B, in which an irregular tank 350 has an inner vessel 354 that is constrained within an outer vessel 352 using support elements 356a (e.g., a collar) and 356b-d (e.g., stand-off plates or rods). According to embodiments, one or more of 356a-d comprises a series of openings (or grooves or notches) to effectively lengthen a heat path between vessels 352 and 354. In other examples, the collars and/or plates may be located in different positions, and other irregular shapes may be used.

According to embodiments, various materials can be used for the inner and outer vessels. Such materials can include, by way of example, stainless steel (e.g., grade 316L), aluminum (e.g., 1% Si grade, or grade 5083 or 5456), and plastics. In some embodiments, the support structure (e.g., a collar) is formed of a low thermal conductivity material, such as stainless steel or an alloy comprising titanium and aluminum. In some embodiments, one or more of the inner and outer vessels comprise aluminum, plastic, and/or a composite material. In some embodiments, one or more natural materials (e.g., natural fiber composites and resins) may be used for the inner and outer vessels, as well as the support elements. The various components (e.g., the vessels and collar) can be connected using standard practices, including bolting and gluing for example.

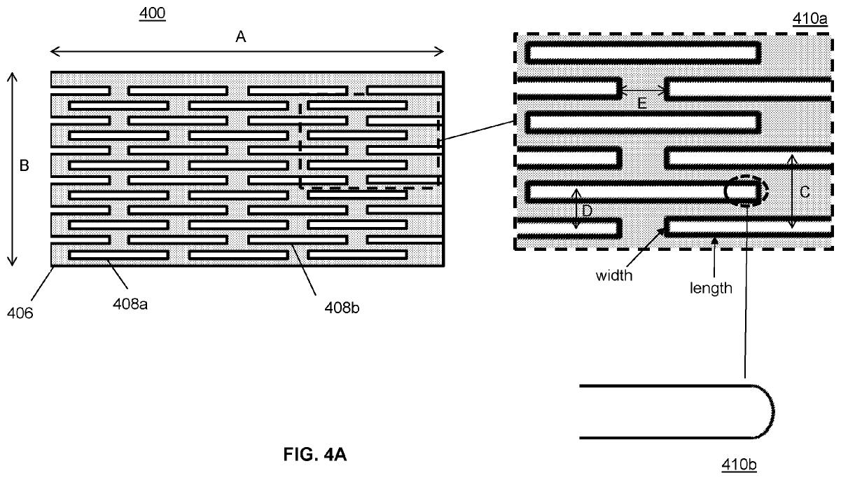

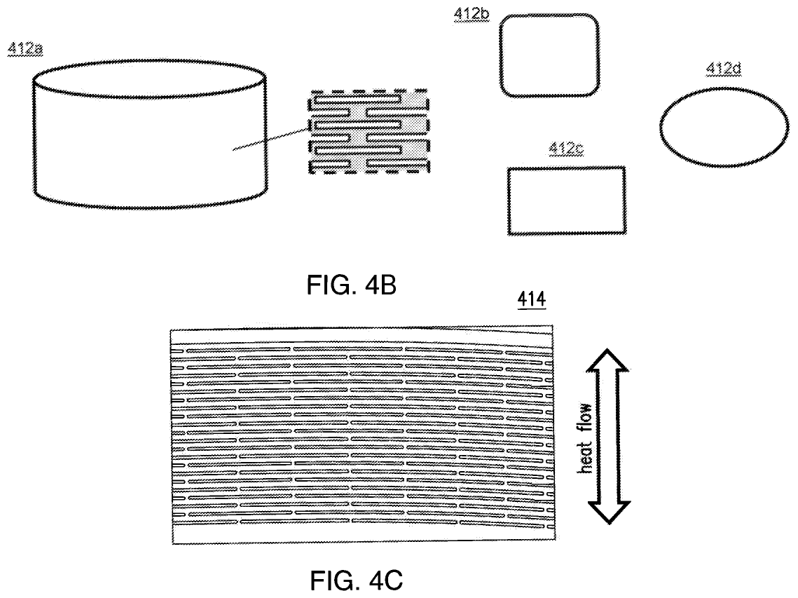

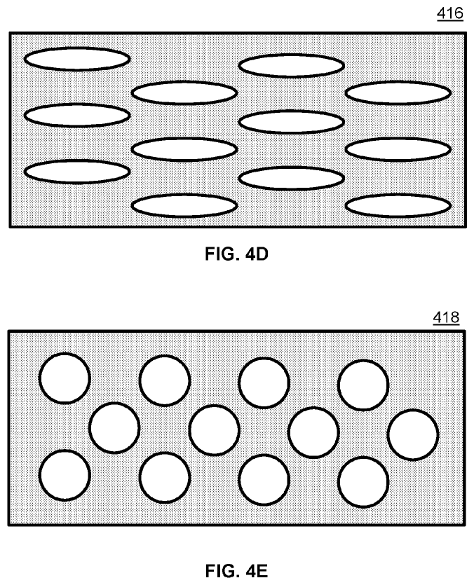

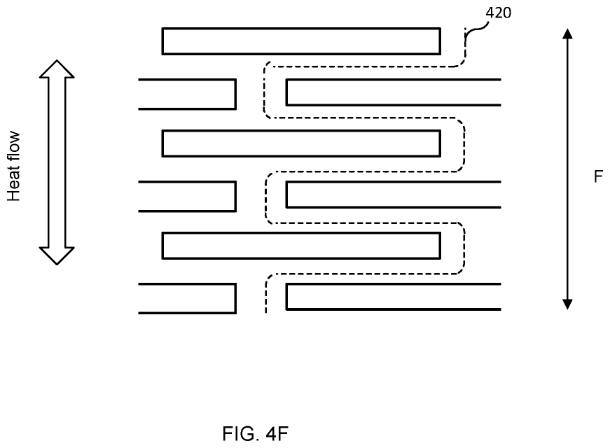

According to embodiments, examples of opening patterns of a support structure are shown in FIGS. 4A-4F.

Referring now to FIG. 4A, a pattern of openings 400 is illustrated according to an embodiment. In this example, a number of openings 408a, 408b are provided in a support structure (e.g., 306). For instance, the openings 408a, 408b may be cut through a sheet 406 of length “A” and width “B” that forms a support structure, or a portion of a support structure. In this embodiment, the openings are arranged in a repeating pattern of rectangles, each with a length and width. In certain aspects, the rectangles may have one or more curved features 410b. This could be the result of, for instance, the technique used to manufacture the opening. As an example, use of a water jet cutting technique may generate rectangular openings that do not have perfect, 90-degree corners. Further, rounded edges may reduce stress levels on the structure.

In the example of FIG. 4A, the rectangular openings are arranged in rows (e.g., first and second rows, which repeat) that are separated by a distance “D”. Within a given row, the rectangles may be spaced apart from each other by a distance “E”. In some embodiments, the rows are offset from each other. For instance, the openings of a first row may be offset in a lengthwise direction from the openings of a second row. This could be, for example, by an amount of half the length of an opening. Other offset lengths may be used as well. Additionally, the spacing between the rows may be regular or irregular. For instance, and with reference to FIG. 4A, the distance “C” between a first and third row may be more or less than twice the distance “D.” Alternatively, distance “C” may be twice distance “D.” That is, the offset rows may be evenly spaced in the vertical direction (e.g., in the primary direction of heat flow). In the example of FIG. 4A, the repeating pattern of openings covers substantially the entire surface of the support element.

In embodiments where the support element(s) are in the form of a collar, a sheet (e.g., sheet 406) can be wrapped or otherwise arranged/bent to form a collar 412, as illustrated in FIG. 4B. The shape of such a collar may be cylindrical 412a or any other closed structure. The shape of such closed structure in top view may be rounded rectangular or rounded square 412b, a rectangle or square 412c, or circular or elliptical 412d, for example. As shown in FIG. 4B, the support elements 412 include a pattern of openings. While closed collars are illustrated in FIG. 4B, other shapes and arrangements may be used to form the support elements of a tank. For instance, open shapes may be used, irregular shapes may be used, and one or more independent elements (e.g., one or more connecting plates or rods) may be used. In such embodiments, these elements (e.g., connecting plates) can also have a pattern of openings.

Referring now to FIG. 4C, another view of the pattern of openings is illustrated 414. Additionally, a direction of heat flow (top to bottom) is shown. In this example, the heat flow in the marked direction is reduced by the openings. That is, according to embodiments, the openings are arranged perpendicular (or substantially perpendicular) to the primary direction of heat flow between the inner and outer vessels.

According to embodiments, other shapes may be used for the openings. For instance, elliptical shaped openings 416 are illustrated in FIG. 4D, and circular shaped openings 418 are illustrated in FIG. 4E.

An example of a heat path 420 through the support element (e.g., 412) is illustrated in FIG. 4F, with the primary direction of heat flow (e.g., between the contact points at the inner vessel and the outer vessel) shown for reference. The heat path 420 is longer than a straight heat path across the support element, which would have a length of “F” without the openings.

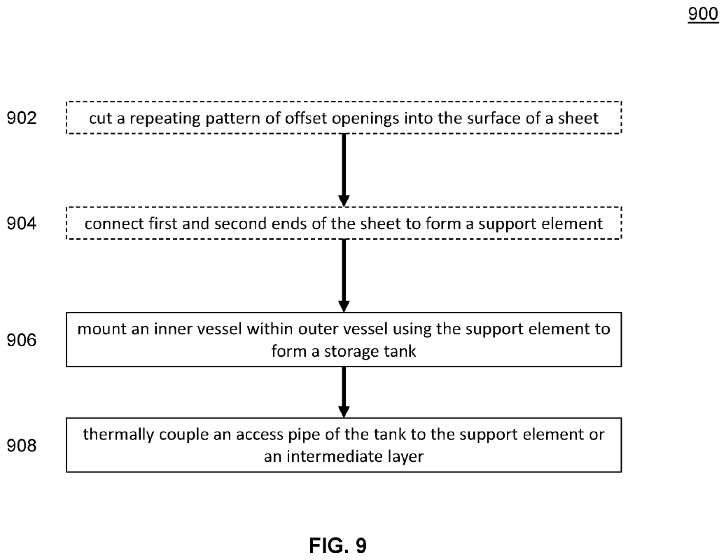

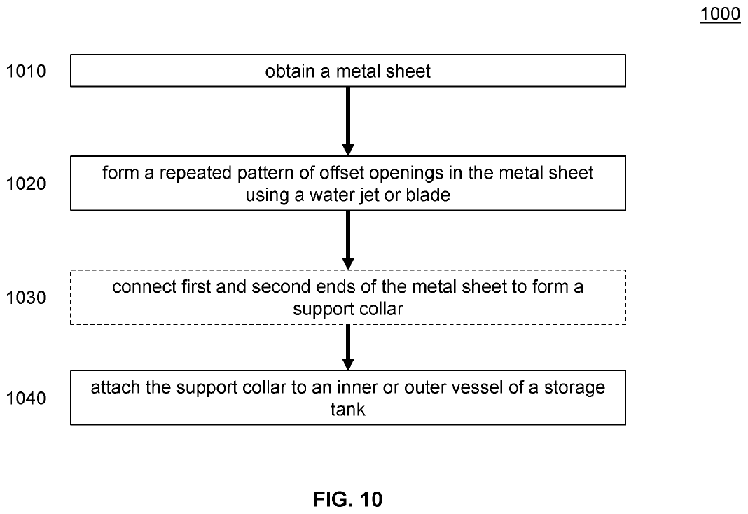

While certain embodiments use full openings as an example, according to other embodiments, patterns may be used that do not fully penetrate through the support element. For instance, notches or partial cuts (e.g., v-cuts or grooves) may be used. Such patterns and support structures may be manufactured using the same techniques as described in connection with FIGS. 9 and 10.

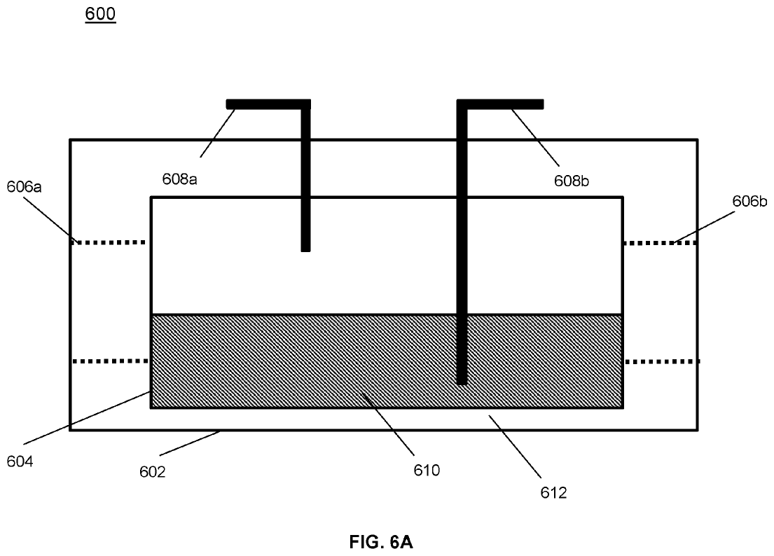

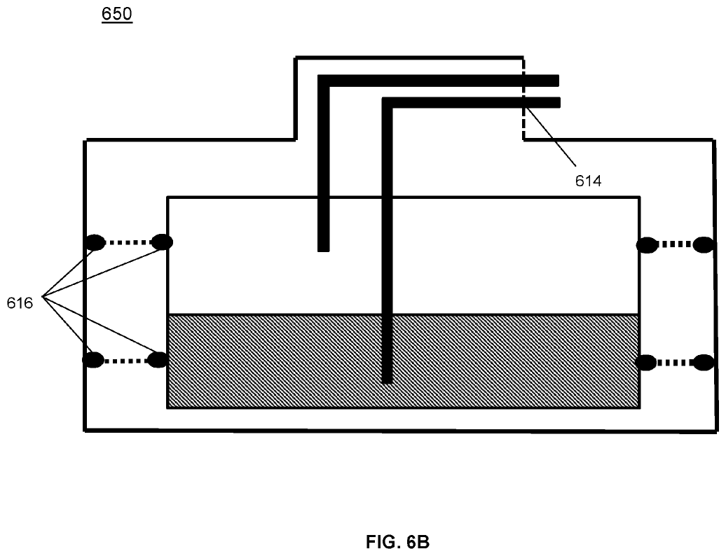

According to embodiments, a support collar is provided with a staggered cut out pattern that increase the heat path length, for instance, as shown in FIGS. 4A-4F. The pattern and dimensions can be optimized considering the following options: (i) cutting length can be reduced by only using a single cut, and not a cut-out box, for the openings, which may reduce the width of an opening in some instances; (ii) increasing the heat path length by having longer cuts/openings, and thus, reducing the area that functions as support beams; (iii) increasing heat path length by using more openings; (iv) increasing strength by reducing the length of the openings or increasing the spacing “E;” and (v) using support structures in multiple locations in the tank to improve support (e.g., as shown in FIGS. 3B, 6A, and 6B).

Some examples of dimensions are provided below, according to embodiments. For a metal sheet used to form a cylindrical collar having an approximate diameter of 1 m, between 10 and 30 openings may be used in a row, and between 5 and 25 rows may be used over a collar height of approximately 0.3 m. The length of the openings may be in the range of 40-200 mm. The width of the openings may be in the range of 0.5-1 mm, for instance, when using water jet CNC cutting technique. The spacing “C” and “D” may be in the range of 5-50 mm and 2.5-45 mm, respectively. The spacing “E” may be in the range of 2-50 mm Other dimensions may be used. In some embodiments, the total connective area around the circumference is approximately 5-6% (e.g., 5.6%), with 20 lots of 1 degree bridges. In certain aspects, the gap changes with the volume of vessel and circumference. For instance, if the tank were longer (e.g., more volume) then the supports would be wider, as there is more mass to support. This could mean a higher percentage of circumference is used. If the tank has a bigger circumference, the bridges reduce in degrees and there will be more of them (similar thickness), having the same percentage.

In some embodiments, the openings comprise approximately 30% of the area around the periphery of a support structure (e.g., between 20-40% of the area). In some embodiments, the openings comprise more than 30% of the area, and in some instances, more than 50%. In certain aspects, the repeating pattern of openings extends over substantially the entire surface of the support structure.

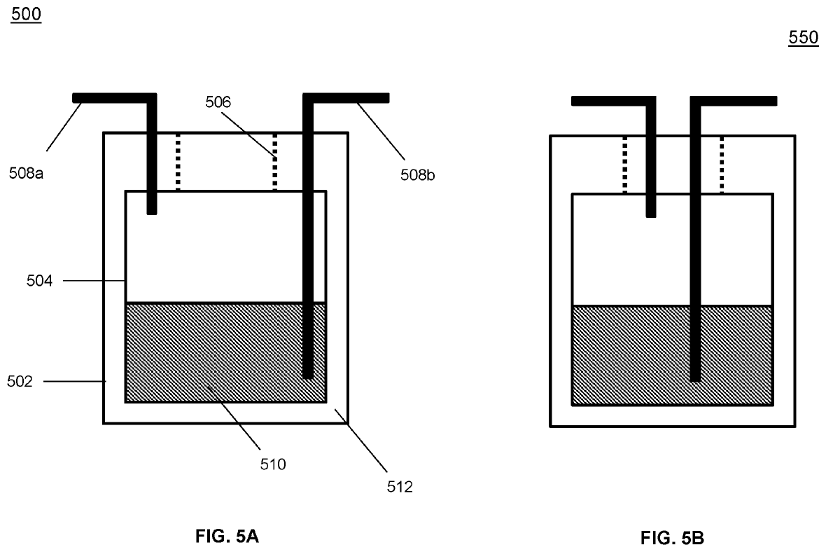

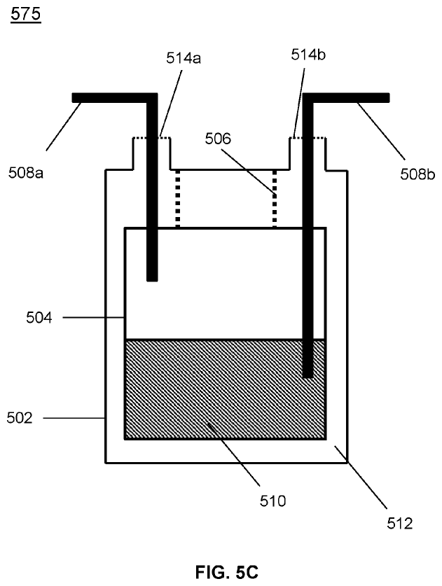

Referring now to FIG. 5A, a cross section of a storage system (e.g., tank) 500 is illustrated according to embodiments. In this example, an inner vessel 504 is supported within an outer vessel 502 using a support structure 506. The support structure may have, for instance, a repeating pattern of openings as illustrated with respect to FIGS. 4A-4F. According to embodiments, the support structure 506 is a collar. In other embodiments, it may be one or more connection plates, for instance. The tank 500 further comprises first and second access pipes 508a, 508b. The access pipes 508a, 508b can be used to access to the inner vessel 504 for filling and retrieving a cryogenic liquid or gas 510. In this example, pipe 508a may be used for retrieval of gas, while pipe 508b is used for retrieval of liquid. This may change depending on the amount of the material 510 in the tank. Additionally, either pipe 508a, 508b can be used for filling the tank 500. The tank 500 further includes a vacuum region 512. According to embodiments, the tank may also have (or have as an alternative to vacuum) an intermediate layer, such as a radiation shield or insulating film (e.g., a multilayer film).

According to embodiments, one or more of the access pipes 508a, 508b can also use a repeating pattern of openings, notches, and/or grooves to help reduce heat transfer. For instance, the access pipes 508a, 508b may have a multi-layer structure, where at least one of the layers has openings to effectively lengthen the heat path along the pipe. In some embodiments, the access pipes 508a, 508b may also support the tank, and may be used in place of support structure 506 to constrain inner vessel 504 within outer vessel 502. In some embodiments, an access pipe may use a first, internal layer (e.g., hose layer or other enclosed structure), with a secondary structural layer. The structural layer may be implemented with a long heat path design.

In the embodiment shown in FIG. 5B, both access pipes 508a, 508b are located within the perimeter of the support structure 506 (e.g., a collar). However, in some embodiments and as shown in FIG. 5A with respect to tank 500, both of the access pipes can be located outside of the support structure. In some instance, a first pipe (e.g., 508b) may be within the support structure, while a second pipe (e.g., 508a) is outside the support structure.

Referring now to FIG. 5C, a tank 575 is illustrated according to some embodiments. In this example, the outer vessel 502 comprises one or more extension regions 514a, 514b. The access pipes (e.g., pipes 508a, 508b) can pass through these regions to increase the length of the pipe that is within the tank 575. This can increase the length between the warm parts of the tank 575 and the cold parts. For instance, where vacuum 512 is used, such an arrangement can extend the length of a pipe within a cold, vacuum region. In certain aspects, the number of extension regions 514a, 514b can be matched to the number of access pipes of the tank 575. According to embodiments, an outer vessel may comprise one or more protrusions that serve as the extension regions.

Referring now to FIG. 6A, a storage system (e.g., tank) 600 is illustrated according to some embodiments. In this example, the inner vessel 604 is mounted within outer vessel 602 using multiple support structures 606a, 606b. For instance, the support structures 606a, 606b may be used at opposite ends of the vessels 602, 604 (e.g., in a lengthwise direction) to constrain the inner vessel 604 within the outer vessel 602. At least one of the support structures 606a, 606b comprises a plurality of openings (e.g., as described with respect to FIGS. 4A-4F). In some embodiments, the support structures 606a, 606b can be mounted on the sides of the tank instead of the ends. Similarly, one or more of the support structures may be on the ends, while one or more are located on the sides. The example of FIG. 6A uses two structures 606a, 606b; however, more support structures may be used as necessary for a given load requirement. Additionally, different types of support structures may be used. For instance, a collar may be used in one location, while a plate is used in another. As with the tanks of FIGS. 3A, 3B, and 5A-5C, a vacuum layer 612 may be used, as well as a radiation shield and/or insulating film (e.g., a multilayer film) to reduce radiative heat transfer.

In the example of FIG. 6A, the access pipes 608a, 608b access the stored material 610 through a side of the tank 600 (e.g., through the sides of vessels 602 and 604). The pipes can be provided through the longitudinally extending surface of the vessels. However, the access pipes 608a, 608b can also be arranged on one or more ends of the tank 600, for instance, as illustrated with respect to FIGS. 5A-5C. The pipes can be arranged, within, partially within, or outside of the support structures 606a, 606b.

Additionally, and as shown in FIG. 6B, extension regions 614 (e.g., as described in connection with FIG. 5C) may also be used in connection with the access pipes 608a, 608b and the outer vessel 602. Further, one or more low thermal conductivity layers barriers 616 can be used in some embodiments. Instead of a direct connection between the vessels and the long heat path support structures, an intermediate standoff can be used to further limit head conduction. This could be, for instance, a low thermal contact barrier (e.g., collar or insert) made from a material such as Kevlar® (or another aramid or para-aramid material).

According to some embodiments, one or more of the access pipes of a storage tank can be thermally sunk to a long heat path support structure or intermediate layer to reduce heat load. For instance, an access pipe used to vent or retrieve boil-off gas can be placed in contact with (or very close to) the support structure. In effect, the “cold” of the access pipe and boil-off gas is re-used to reduce heating. The same principle can be applied to a cryogenic liquid line, where the removal (or filing) of the liquid can reduce heat load of structures as it passes by. According to embodiments, the diameter of the liquid access pipe is modified to accommodate a change of liquid into gas. For instance, a pipe may have a smaller bore initially for liquid phase material, but a larger diameter for gaseous phase material. In some embodiments, boil-off gas can be sunk to an intermediate layer or support structure with a single, meandering pipe. However, in other embodiments, the flow can be split using a manifold to spread the contact regions.

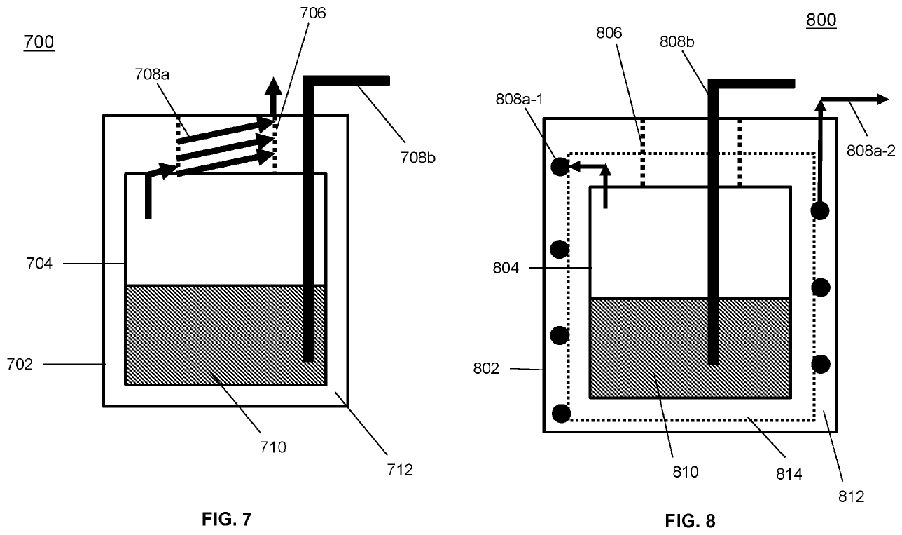

Referring now to FIG. 7, a storage system 700 is illustrated according to some embodiments. In this example, an inner vessel 704 is mounted within an outer vessel 702 using a support structure 706, with an optional vacuum layer 712 (or other intermediate layer, not shown). The tank 700 further comprises one or more access pipes 708a, 708b. In some embodiments, at least one of the pipes is thermally coupled to the support structure 706. For instance, access pipe 708a (e.g., a gas or liquid access pipe) can be near or in contact with the support structure. For instance, the access pipe 708a can be wrapped around the support structure 706 (e.g., forming a coil about the support structure). While only one access pipe is shown thermally coupled to the support structure 706 in FIG. 7, according to embodiments, two or more access pipes can be thermally coupled to the support structure. For instance, both a gas and liquid access pipe can be arranged in contact with the support structure 706 (e.g., wrapped about or mounted directly onto the support structure 706) to reduce heat load as either gas or liquid is passed through the pipe to or from the reservoir of cryogenic material 710. As an example, boil-off gas may pass through pipe 708a and cool the support structure.

Referring now to FIG. 8, a storage system (e.g., tank) 800 is illustrated according to some embodiments. In this example, an inner vessel 804 is mounted within an outer vessel 802 using a support structure 806, with an optional vacuum layer 812. In this embodiment, an additional intermediate layer 814 is used. The intermediate layer may be, for instance, a radiation shield or insulating layer (e.g., a multi-layer film) used to limit heat transfer to or from the inner vessel 804, which contains cryogenic material 810. In some embodiments, the intermediate layer may be in contact with (e.g., thermally coupled to) the support structure 806. The tank 800 further comprises one or more access pipes 808a and 808b. In some embodiments, at least one of the pipes (e.g., 808a) is thermally coupled to the intermediate layer 814. For instance, access pipe 808a (e.g., a boil-off gas pipe) can be near or in contact with the intermediate layer 814. For instance, the access pipe 808a can be wrapped around the intermediate layer 814 (e.g., forming a coil about the intermediate layer). The wrapping of access pipe 808a is illustrated in FIG. 8 as an example, with cross-section 808a-1 illustrating the wrapping of the access pipe as it coils about the intermediate layer 814. The portion 808a-2 shows the access pipe as it leaves the tank 800. While only one access pipe is shown thermally coupled to the intermediate layer 814 in FIG. 8, according to embodiments, two or more access pipes can be thermally coupled to the intermediate layer. For instance, both a gas and liquid access pipe can be arranged in contact with the intermediate layer 814 (e.g., wrapped about or mounted directly onto the intermediate layer 814) to reduce heat load as either gas or liquid is passed through the pipe to or from the reservoir of cryogenic material 810.

According to embodiments, the features of FIGS. 7 and 8 may be combined such that one or more pipes is thermally sunk to a support structure while one or more other pipes is thermally sunk to an intermediate layer. Similarly, one or more individual pipes may be thermally sunk to both the support structure and the intermediate layer.

Referring now to FIG. 9, a process 900 for assembling a support structure and storage system (e.g., tank) is provided according to some embodiments. Process 900 may be used, for instance, in manufacturing one or more of the tanks and sub-components shown in FIGS. 3-8.

Process 900 may begin with optional step 902 in some embodiments. In step 902, a repeating pattern of offset openings is cut into a sheet (e.g., a sheet of metal). For instance, one or more of the patterns of openings shown in FIGS. 4A-4F are cut into the surface of the sheet. The openings can be formed, for instance, using a blade, laser cutting, stamping process, or water jet. The cuts need not be formed with vertical sidewalls.

In optional step 904, first and second ends of the sheet are connected to form a support element. For instance, a sheet having a pattern or openings may be wrapped to form a collar. In some embodiments, the ends of the sheet are not fully connected, and instead, step 904 comprises bending the sheet to form a non-connected shape as a support element. In some embodiments, step 904 may not be used, and a sheet (e.g., 406) can be used, without bending, as a connecting plate to support an inner vessel. In some embodiments, step 904 may comprise folding one or more surface of the support structure to form an s- or according-shaped wall.

In step 906, an inner vessel is mounted within the outer vessel using a support element to form a storage tank. For instance, the support element formed in steps 902 and 904 may be used. According to embodiments, the vessels are connected by the support element as shown in FIGS. 3A, 3B, 5A-5C, 6-8, and 12.

In step 908, one or more accesses pipes of the tank are thermally coupled to the support element or an intermediate layer, for instance, as illustrated with respect to FIGS. 7 and 8. Step 908 may be optional in some embodiments. In certain aspects, step 908 may comprise inserting or otherwise attaching pipes to the tank.

Referring now to FIG. 10, a process 1000 for assembling a support structure and a storage system (e.g., a tank) is provided according to some embodiments. Process 1000 may be used, for instance, in manufacturing one or more of the tanks and sub-components shown in FIGS. 3-8.

According to embodiments, process 1000 may begin with step 1010 in which a metal sheet is obtained (e.g., sheet 406).

In step 1020, a repeating pattern of offset openings is formed in the metal sheet using, for instance, a water jet or blade. Depending on the width of the openings, the openings can be formed with a box cut (e.g., around the perimeter of the opening) or a single cut (e.g., using the width of a blade or water jet to define the width of the opening). The pattern may be, for instance, any of the patterns described in connection with FIGS. 4A-4F.

In step 1030, first and second ends of the metal sheet are connected to form a support collar. The collar may be cylindrical, or another shape as described in connection with FIG. 4B. In embodiments where a connecting plate is used, step 1030 may be omitted. In some embodiments, step 1030 may comprise folding one or more surface of the support structure to form an s- or according-shaped wall. In some embodiments, the process may stop with step 1020 or 1030, for instance, with the formation of a support collar or plate.

In step 1040, the support collar (or plate) is attached to an inner or outer vessel of a storage tank.

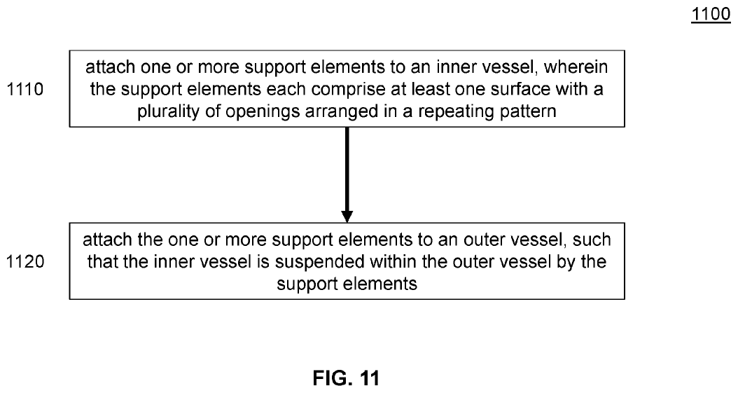

Referring now to FIG. 11, a process 1100 for assembling a storage system (e.g., tank) is provided according to some embodiments. Process 1100 may be used, for instance, in manufacturing one or more of the tanks shown in FIGS. 3-8 and 12. In step 1110, one or more support elements are attached to an inner vessel, wherein each of the support elements comprises at least one surface with a plurality of openings arranged in a repeating pattern. In step 1120, the one or more support elements are attached to an outer vessel, such that the inner vessel is suspended within the outer vessel by the support elements. The steps may be performed in a different order, wherein the support structure is first attached to the outer vessel.

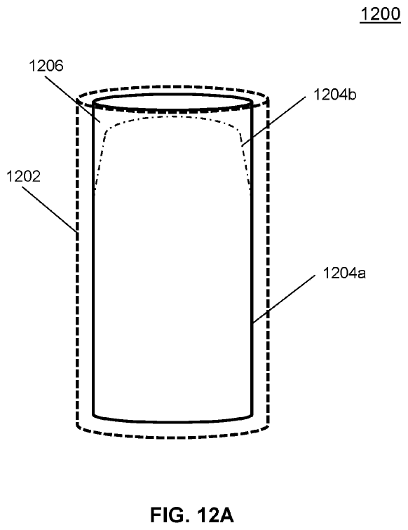

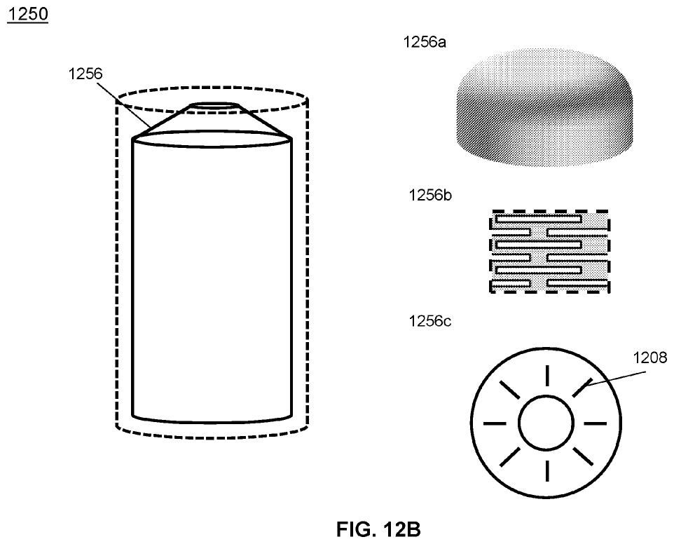

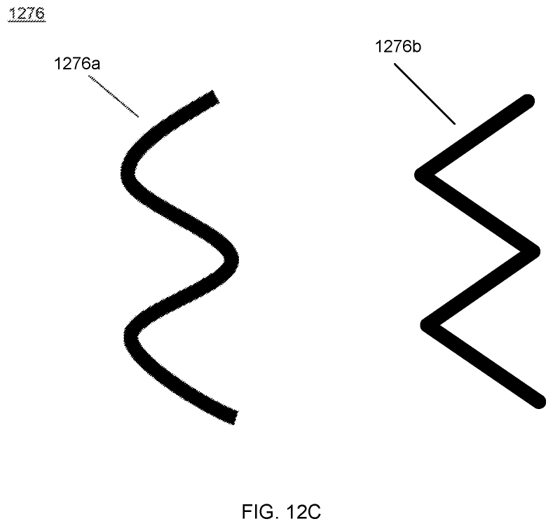

Referring now to FIG. 12A, a storage system (e.g., a tank) 1200 is illustrated according to some embodiments. In this example, an inner vessel 1204 is mounted within an outer vessel 1202 using a support structure 1206. According to embodiments, a repeating pattern of offset openings is provided in the support structure 1206. For instance, one or more of the patterns of openings shown in FIGS. 4A-4F can be cut into the surface of support structure 1206. As shown in FIG. 12A, the support structure 1206 can be arranged over the inner vessel 1204 (e.g., a support collar can be used that sits around the outside of the inner vessel). For instance, the inner vessel 1204 could have a first portion 1204a and a second portion 1204b of different diameters, where the supports structure 1206 fits over the narrower portion 1204b (e.g., like a cap). In other embodiments, the inner vessel 1204 may have a uniform diameter with the support structure 1206 arranged over the inner vessel 1206. In some instance, the support structure 1206 can have a similar shape and design as illustrated and described with respect to FIG. 12B.

Referring now to FIG. 12B, a storage system (e.g., a tank 1250) is illustrated according to some embodiments. In this example, a support structure 1256 can be used. For instance, a domed circular element can be used, as shown as 1256a. While illustrated with rounded sides, straight sides could be used. In some embodiments, 1256 has a frusto-conical shape (e.g., a cone or pyramid with its tip truncated along a plane parallel to the base). The frustum could have rounded sides, or a series of flat sides (e.g., a frustum of a decagonal pyramid). According to embodiments, a series of repeated openings 1256b can be used, for instance, as illustrated with respect to FIGS. 4A-4F. In some embodiments, the support element 1256 (e.g., cap) can use one or more radial slots 1208. An example in plan view is shown as 1256c. The support system 1256 can be used, for example, in the tanks of FIGS. 3A, 3B, 5A-5C, 6A, 6B, 7, and 8 to connect an inner vessel to an outer vessel. In some embodiments, the top of element 1256 attaches to a central region of an end of an outer vessel, while the bottom of element 1256 attaches to a perimeter region of an end of an inner vessel.

Referring now to FIG. 12C, and according to some embodiments, a support structure (e.g., 306, 356, 406, 506, 606, 706, 806, 1206, and 1256) can have a folded design. For instance, one or more surfaces/sidewalls of a support structure 1276a, 1276b can fold back in on itself (e.g., as with bellows bags). This would further lengthen the heat path, and provide an additional element of mechanical compliance. That is, in certain aspects, a support structure 1276a, 1276b could act like a spring. Similarly, pipe work (e.g., 508, 608, 708, and 808) could also have “S” or accordion-like bends to allow the inner vessel to move on the collar support. That is, one or more of the pipes could have the same (or similar) shape as illustrated with respect to 1276a, 1276b. In certain aspects, support structures and pipes with such a shape could be included in a vehicle application such as a truck or car where the system has to survive collisions. It would also allow a very short distance between the inner and outer tank giving higher volumes.

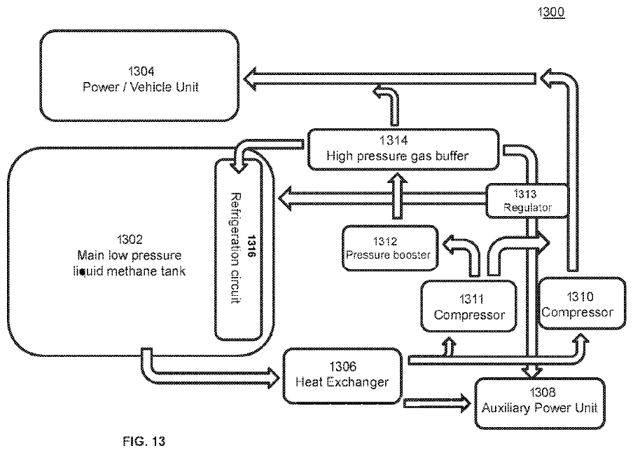

In some embodiments, the tank and suspension systems of the present disclosure can be used in the fuel delivery system shown in FIG. 13 (e.g., as main low pressure tank 302, or one or more gas buffers).

Referring now to FIG. 13, a system 1300 for the storage and delivery of a fuel, for instance methane, is provided according to some embodiments. The system may comprise a low pressure fuel storage tank 1302. However, higher pressure tanks may be used. In some embodiments, tank 1302 has a non-cylindrical cross-section, such as a square or rounded rectangular cross-section. Although square and rounded rectangle shapes are used in this example, other non-cylindrical cross-sections could be used. Additionally, the tank 1302 could have a complex shape, for instance, an “L” shape. For instance, the tank may be shaped to fit the vehicle of the fuel delivery system. According to embodiments, any of the storage systems described herein may be used as tank 1302, including the use of any of the support structures described herein to mount tank 1302. For example, tank 1302 may be mounted with a support structure comprising at least one surface with a plurality of openings arranged in a repeating pattern, as described with respect to FIGS. 3A, 3B, 4A-4F, 5A-5C, 6A, 6B, 7, and/or 8. In embodiments, the tank and power unit are operatively coupled. For instance, they may be coupled such that fuel is delivered from tank 1302 to power unit 1304, which could be, for instance, an engine (e.g., a combustion engine) or other power device of a vehicle. This may be accomplished using one or more pipes and/or intermediate stages between the tank 1302 and power unit 1304. As used herein, the term vehicle includes, but is not limited to, ground-based vehicles (such as cars, trucks, motorcycles, and tractors), sea-based vehicles (such as boats), and air-based vehicles (such as airplanes or drones).

The system may also optionally include a heat exchanger 1306, an auxiliary power unit 1308, a liquefaction/refrigeration circuit 1316, a gas compressor 1310, and/or a high pressure buffer and booster 1314 and 1312. The system may be configured so that the liquid methane is held at the lowest possible temperature, thereby increasing the energy density to its maximum. As with tank 1302, any of the storage systems described herein may be used as storage or a buffer (e.g., buffer 1314), including the use of any of the support structures described herein to mount such structures.

In some embodiments, upon receiving a demand for gaseous methane, the compressor 1310 is powered up, forcing gas into the engine 1304. Gas may also be forced back into the tank via a regulator, pressurizing the tank to force more liquid methane out through the heat exchanger 1306, where it is vaporized before being compressed and forced into the engine to continue the cycle. That is, gas may be passed to the tank 1302 from compressor 1310 (or 1311) via regulator 1313. In this way, the components of system 1300 may be used in conjunction to simultaneously deliver the necessary fuel to unit 1304 (e.g., an engine) while ensuring that additional fuel will be vented from tank 1302 for sustained delivery and use. In some embodiments, fuel may be delivered to power unit 1304 based on the pressure of tank 1302, without the need for one or more of the intermediate stages.

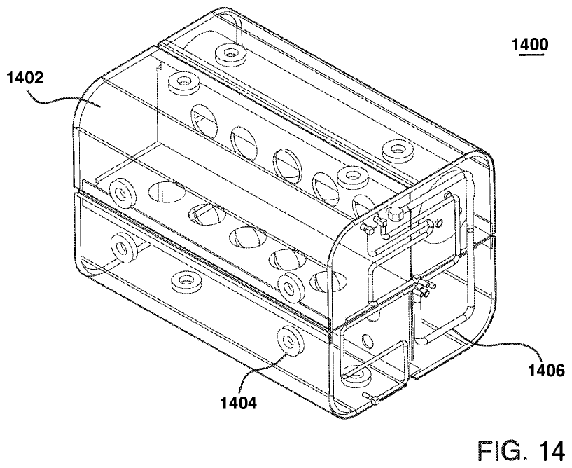

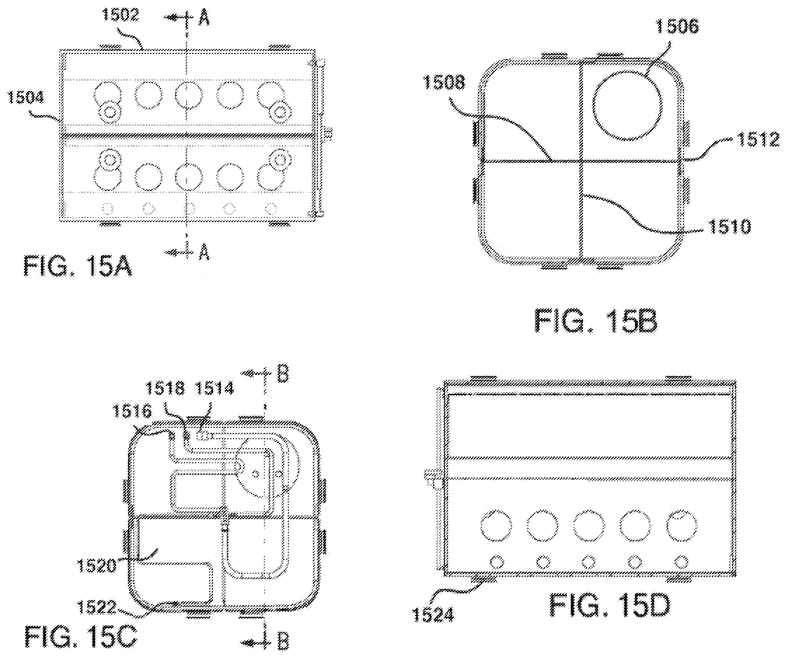

In some embodiments, non-cylindrical tanks such as those illustrated in FIGS. 14, 15A-D, and 16 can be mounted using one or more of the support systems described in the present disclosure. That is, the support systems (e.g., collars, plates, and other support structures) described herein may be used in addition to, or in place of, the support elements shown in FIGS. 14, 15A-D, and 16.

Referring now to FIG. 14, a storage vessel 1400 is provided according to some embodiments. The vessel 1400 may include an outer surface 1402, one or more connection points, 1404, for instance, for a suspension system, and piping 1406. According to embodiments, storage vessel 1400 may correspond to the inner vessel.

Referring now to FIGS. 15A-15D, detailed views of a storage vessel, such as vessel 1400, are provided according to some embodiments. In this example, 1502 is a rounded section and 1504 is an end plate, rear side. FIG. 15B is a cross-section taken along “A” of FIG. 15A. As shown in the example of FIG. 15B, 1506 is an ullage cylinder, 1508 is a horizontal reinforcement, 1510 is a vertical reinforcement, 1512 identifies flanges, 1514 is a fill line, 1516 is vent line, 1518 is a gas line, 1520 is an end plate, side, and 1522 is a liquid line. FIG. 15D is a cross-section taken along “B” of FIG. 15C. A connection point 1524 is illustrated, which may be, for example, a capstan. In some embodiments, the capstans are positioned in the same dimension on each side.

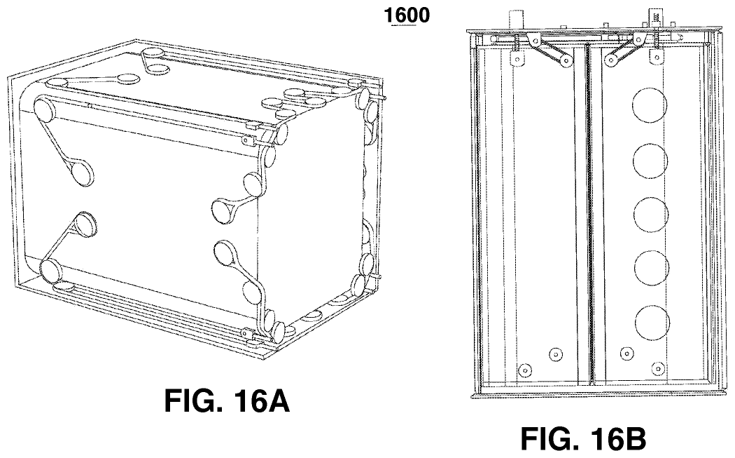

Referring now to FIGS. 16A and 16B, FIGS. 16A and 16B illustrate two views of a vessel 1600 with rope (e.g., a synthetic rope such as Kevlar®) and Belleville washers according to some embodiments. As some materials may be stiff (e.g., Kevlar®) and not stretch before failure, embodiments provide for some compliance in case of mechanical shock. For instance, a threaded tensioning arrangement can be used to tighten the rope, and also Belleville washers may be selected to provide the appropriate amount of tension. Although Kevlar® is used in this example, according to embodiments, other suitable materials could be used.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-58. (canceled)

59. A storage system, the storage system comprising:
an outer vessel;
an inner vessel arranged within the outer vessel; and
a support structure connecting the inner vessel to the outer vessel,
wherein the support structure comprises at least one surface with a plurality of openings arranged in a repeating pattern.

60. The storage system of claim 59, wherein the plurality of openings comprise a first row of openings and a second row of openings, and wherein the openings of the first row are offset from the openings of the second row.

61. The storage system of claim 59, wherein the support structure comprises a collar having an outer surface, and wherein the plurality of openings are cut through the outer surface.

62. The storage system of claim 61, wherein the repeating pattern of openings extends over substantially all of the outer surface of the collar.

63. The storage system of claim 59, further comprising:
one or more access pipes for input or extraction of cryogenically stored liquids or gases.

64. The storage system of claim 63, wherein at least one of said access pipes is thermally coupled to the support structure.

65. The storage system of claim 63, wherein at least one of said access pipes is wrapped around the support structure.

66. The storage system of claim 63, wherein the outer vessel comprises one or more extension regions, and wherein at least one of the access pipes is located at least partially in an extension region of the outer vessel.

67. The storage system of claim 63, wherein a first access pipe of said one or more access pipes has a different diameter than a second access pipe of said one or more access pipes, and wherein the first access pipe is for a gas and the second access pipe is for a liquid.

68. The storage system of claim 59, the storage system further comprising:
an intermediate layer interposed between the inner and outer vessels of the system, wherein at least one access pipe is thermally coupled to the intermediate layer.

69. The storage system of claim 68, wherein the intermediate layer is a mechanically solid support structure.

70. The storage system of claim 59, the storage system further comprising:
an intermediate layer interposed between the inner and outer vessels of the system, wherein at least one access pipe is wrapped around the intermediate layer.

71. The storage system of claim 59, wherein the support structure comprises a first support element and a second support element, and wherein the first support element is a first collar and the second support element is a second collar.

72. The storage system of claim 59, wherein the support structure comprises a first support element and a second support element, and wherein the first and second support elements are located at opposing ends of the storage system along a longitudinal direction of the support system.

73. The storage system of claim 59, wherein the support structure has a frusto-conical shape.

74. The storage system of claim 59, wherein at least one surface of the support structure has a folded layout.

75. The storage system of claim 59, wherein one or more of the inner and outer vessels has a non-cylindrical shape.

76. The storage system of claim 59, wherein the repeating pattern of openings comprises at least 5 rows of openings.

77. A cryogenic storage tank, comprising:
an outer tank;
an inner tank; and
at least one support collar for mounting the inner tank within the outer tank,
wherein the at least one support collar comprises means for extending an effective heat path length between the outer tank to the inner tank.

78. A fuel delivery system for a vehicle, comprising:
a storage tank; and
an engine operatively connected to the storage tank and configured to operate using fuel from the storage tank,
wherein the tank comprises an inner vessel and an outer vessel connected by a support structure that comprises at least one surface with a plurality of openings arranged in a repeating pattern.
